(19) United States
(12) Patent Application Publication
(10) Pub. No.: US 2006/0049100 A1
(43) Pub. Date: Mar. 9, 2006

(54) Medium and high viscosity hydrocarbon collecting net

(76) Inventor: Anivaldo da Cruz Grossi, Belem (BR)

Correspondence Address: Bachman & LaPointe, Suite 1201, 900 Chapel Street, New Haven, CT, 06510-2802, US

(21) Appl. No.: 10/538,469

(22) PCT Filed: Dec. 9, 2003
(86) PCT No.: PCT/BR03/00193

§ 371 Date: Jun. 9, 2005

(30) Foreign Application Priority Data
Dec. 9, 2002 (BR) PI0204994-5
Dec. 5, 2003 (BR) CI0204994-5

(51) Int. Cl. B01D 39/00

(52) U.S. Cl. 210/483

(57) ABSTRACT

Medium and high viscosity hydrocarbon collecting net comprising a net of polypropylene strands forming a cross-linked area to allow penetration and retention of medium and high viscosity hydrocarbon; a frame of polypropylene strip attached in the whole periphery of the net; and handle devices in the corners of the frame for installation of snap connections with the aim to increase the collecting area of medium and high viscosity hydrocarbon.

### FIELD OF INVENTION

The present invention relates to a net for collecting hydrocarbons spilled on water surface in particular surface of seas, rivers, lakes and the like and also in the surface of sand in the margin of the same.

### DESCRIPTION OF THE STATE OF THE ART

Until today it is not known any device capable of immobilizing and/or direct, retain and collect hydrocarbon spots of medium and high viscosity in liquid surfaces thus impeding the spot to reach the margins.

### BRIEF DESCRIPTION OF THE DRAWING

FIG. 1 is a perspective view of the net of present invention attached to a frame with handle devices.

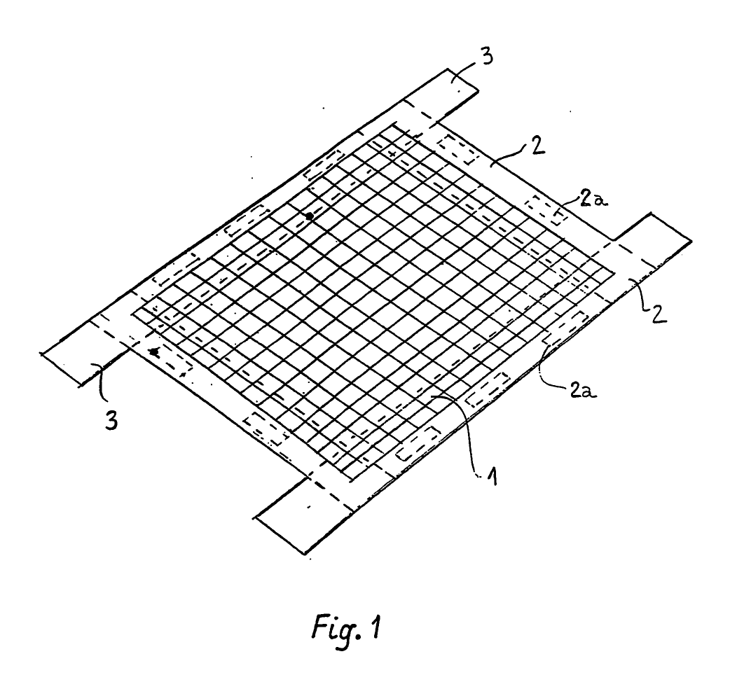

### DESCRIPTION OF THE INVENTION

The present invention uses a net 1 of polypropylene strand and/or other strands of oilphylic materials in any regular shape, for example, square or rectangular. This net is capable of collecting in its cross-linking area the hydrocarbon. The net is installed in a frame 2 of polypropylene or other oilphylic material with sufficient tensile strength as a function of it size and the weight of hydrocarbon in order to collect the same when containing the medium and high viscosity hydrocarbon.

The use of the net of present invention to collect medium and high viscosity hydrocarbon consists of launching said net over the spot of hydrocarbon on the water or sand surface and await the penetration of medium and high viscosity hydrocarbon into the cross-linking area of the net and later perform the operation of removal of the net already with the medium and high viscosity hydrocarbon duly retained in the net. The operation for removal of the net containing the medium and high viscosity hydrocarbon can be made be manual or mechanical means.

The net of present invention has a frame 2 formed by polypropylene strips attached to, for example by sewing, to the polypropylene net in the whole periphery of the same. This frame is formed with handle devices 3 designed to allow the fitting of snap connections for linking several segments in order to increase the application area thereof over the spot of hydrocarbon thus collecting a greater quantity of the same.

In order to improve the conditions as to adsorption of hydrocarbon by the net of present invention there are provided in the longitudinal portions of frame 2 floating elements 2a sandwiched between the upper face and bottom face thereof. Such floating elements 2a provide the net with stability required both prior and after the hydrocarbon adsorption operation. There is also the possibility of the floating elements 2a to be sandwiched between the transverse portions of frame 2.

Preferably, the material employed to build the floating elements 2a is expanded polystyrene. However, any material having floating characteristics and resistance similar to expanded polystyrene can be used without bringing harm to the floatation purposes reached by polystyrene.

1. Medium and high viscosity hydrocarbon collecting net, characterized by comprising:
a net of polypropylene strands forming a cross-linked area to allow penetration and retention of medium and high viscosity hydrocarbon;
a frame of polypropylene strip attached in the whole periphery of the net, and the same having in the longitudinal portions thereof floating elements of floating material sandwiched between the upper face and the bottom face thereof; and
handle devices in the corners of the frame for installation of snap connections with the aim to increase the collecting area of medium and high viscosity hydrocarbon.

2. Net, according to claim 1, characterized in that the net is made of any other oilphylic material.

3. Net, according to claim 1, characterized in that the floating elements of floating material are sandwiched between the supper face and bottom face of transverse portions of the net.
